(19) United States
(12) Patent Application Publication
(10) Pub. No.: US 2024/0310000 A1
(43) Pub. Date: Sep. 19, 2024

(54) PRESSURIZED CYLINDER ADAPTER FOR CARBONATION DEVICE

(71) Applicant: INDIGO SODA LTD, Saint-Eustache (CA)

(72) Inventor: Jonathan Choiniere, Saint-Eustache (CA)

(21) Appl. No.: 18/607,224

(22) Filed: Mar. 15, 2024

Related U.S. Application Data
(60) Provisional application No. 63/490,867, filed on Mar. 17, 2023.

(51) Int. Cl. F17C 13/04; F17C 13/06; F17C 13/08

(52) U.S. Cl. CPC F17C 13/04; F17C 13/06; F17C 13/084; F17C 2205/0311; F17C 2205/0373; F17C 2260/018

(57) ABSTRACT

A pressurized cartridge adapter for connecting a pressurized cartridge to a carbonation device, the pressurized cartridge adapter comprising a socket insert comprising an insert body defining a bore and a first mating interface, the insert body being insertable into a valve head socket of the carbonation device, a pin configured to translate within the bore between a neutral position and an engaged position, the pin being engageable by a gas release mechanism of the carbonation device when in the neutral position, and a cartridge connector configured to be secured to a valve head of the pressurized cartridge, the cartridge connector comprising an annular body defining an internal conduit and a second mating interface, wherein the first and second mating interfaces are configured to mate when the pressurized cartridge adapter is assembled to position the bore of the socket insert in register with the internal conduit of the cartridge connector.

### CROSS REFERENCE

This application claims the benefit of U.S. Provisional App. No. 63/490,867, which was filed on Mar. 17, 2023, the entirety of which is hereby incorporated by reference.

### TECHNICAL FIELD

The technical field relates to fittings for carbonation devices and, more particularly, to adapters for pressurized cartridges.

### BACKGROUND

Carbonation devices are commonly used for the carbonation of water or other liquids. A typical carbonation device may be operated to inject carbon dioxide into water or another liquid contained in a bottle secured to the device. The carbon dioxide gas that is injected into liquid to carbonate the liquid is typically provided in cartridges of compressed or liquefied gas.

The carbonation devices typically include a user-operable mechanism for releasing gas from the cartridge as well as internal conduits for channeling the gas to the liquid to be carbonated. Typically, operation of the gas release mechanism causes the mechanism to open a valve of the cylinder. When the pressurized cartridge is installed within a cartridge compartment of the carbonation device, a valve head of the cartridge (which includes the valve) is connected to a valve head socket of the carbonation device.

When a pressurized cartridge has been emptied of gas, the empty cartridge may be removed from the cartridge compartment and replaced with a full cartridge. This replacement is typically performed by a user of the device but is restricted to the use of a compatible pressurized cartridge. In particular, a valve head socket of the carbonation device may be threaded to only receive a valve head provided with exterior male threading allowing screwing thereof into the interior threading of the socket. Alternatively, the valve head socket of the carbonation device may be dimensioned to mate with a smooth valve head of a pressurized cartridge by interference fit thereby requiring specific dimensioning thereof.

Some cartridge adapters for refilling carbonation devices with non-compatible cartridges are known. However, these adapters are typically mounted above the valve head of the pressurized cartridge thereby increasing a longitudinal length of the cartridge rendering their installation within the cartridge compartment cumbersome or impossible without extensive modification to the carbonation device.

In view of the above, challenges still remain in the field of cartridge adapters for refilling carbonation devices.

### BRIEF SUMMARY

In accordance with an aspect, there is provided a pressurized cartridge adapter for a carbonation device allowing an installation of a non-compatible pressurized cartridge without modification of the carbonation device. The pressurized cartridge adapter comprises a socket insert comprising an insert body defining a bore and a first mating interface, the insert body being at least partially insertable into a valve head socket of the carbonation device, a pin displaceable within the bore of the socket insert, and a cartridge connector configured to be secured to a valve head of the pressurized cartridge, the cartridge connector comprising an annular body defining an internal conduit and a second mating interface, wherein the pressurized cartridge adapter is configurable into an assembled configuration in which socket insert is at least partially inserted into the valve head socket, the first and second mating interfaces mate with each other and the bore of the socket insert is in fluid connection with the internal conduit of the cartridge connector, and wherein, when the pressurized cartridge adapter is in the assembled configuration, the pin is displaceable within the bore between a neutral position and a gas-releasing position in which, upon actuation of a gas release mechanism of the carbonation device, a fluid released by the pressurized cartridge is channeled into the valve head socket of the carbonation device.

In at least one embodiment, when the socket insert is inserted within the valve head socket of the carbonation device and the cartridge connector is secured to the valve head of the pressurized cartridge, the first and second mating interfaces define a mating direction transverse with regards to a longitudinal axis of the insert body.

In at least one embodiment, the first and second mating interfaces are planar surfaces.

In at least one embodiment, the pressurized cartridge adapter further comprises a coupler configured to secure the socket insert and the cartridge connector together when the pressurized cartridge adapter is in the assembled configuration.

In at least one embodiment, the coupler comprises a fastening groove configured to receive an insert flange of the socket insert and a connector flange of the cartridge connector when the pressurized cartridge adapter is in the assembled configuration.

In at least one embodiment, the socket insert comprises an internal surface at least partially delimiting the bore, an attachment recess extending along a portion of the internal surface and being configured to receive at least a portion of the coupler and a connector flange of the cartridge connector.

In at least one embodiment, the socket insert defines a pressure conduit in fluid communication with the bore and opening into an outer surface of the socket insert, the pressure conduit being positioned to channel the pressurized fluid to an inlet of the valve head socket of the carbonation device upon actuation of the gas release mechanism.

In at least one embodiment, an external groove is formed in the outer surface of the socket insert and extends about a circumference thereof, the external groove being configured to channel the pressurized fluid between the pressure conduit of the socket insert and the inlet of the valve head socket of the carbonation device.

In at least one embodiment, the socket insert comprises an insert flange extending radially outwardly from the insert body, the insert flange comprising a valve-abutting interface configured to abut the valve head socket of the carbonation device when in the assembled configuration.

In at least one embodiment, when the pressurized cartridge adapter is in the assembled configuration, the pressure conduit of the socket insert is in register with an inlet of the valve head socket.

In at least one embodiment, the cartridge connector includes a threaded surface at least partially delimiting the internal conduit and configured to engage the valve head of the pressurized cartridge, and wherein the insert body of the socket insert is configured to be slidingly received within the valve head socket of the carbonation device.

In at least one embodiment, the pin comprises a first end engageable with a pin aperture of the socket insert, and a second end opposite the first end operatively connected to a valve of the valve head when the pressurized cartridge adapter is in the assembled configuration.

In at least one embodiment, the pressurized cartridge adapter further comprises a stopper insertable into the bore of the socket insert and defining a pin-receiving cavity.

In at least one embodiment, the pressurized cartridge adapter further comprises a gasket arranged in the bore of the socket and surrounding the stopper to hydraulically seal the pressurized cartridge adapter when in the assembled configuration.

In at least one embodiment, the stopper comprises an internal rib extending within the pin-receiving cavity and configured to limit a translation of the pin within the bore of the socket insert.

In at least one embodiment, the pressurized cartridge adapter further comprises a resilient damper insertable into the bore of the socket insert and configured to dampen a displacement of the pin within the bore of the socket insert.

According to another aspect, there is provided method of connecting a pressurized cartridge to a carbonation device, the method comprising at least partially inserting a socket insert of a pressurized cartridge adapter into a valve head socket of the carbonation device along a longitudinal direction of the socket insert, securing a cartridge connector of the pressurized cartridge adapter to a valve head of the pressurized cartridge, and coupling a first mating interface of the socket insert with a second mating interface of the cartridge connector to position a bore of the socket insert in fluid communication with an internal conduit of the cartridge connector.

In at least one embodiment, at least partially inserting the socket insert of the pressurized cartridge adapter into the valve head socket of the carbonation device comprises abutting a valve-abutting interface of the socket insert with the valve head socket to position a pressure conduit of the socket insert in register with an inlet of the valve head socket.

In at least one embodiment, securing the cartridge connector of the pressurized cartridge adapter to the valve head of the pressurized cartridge comprises threading the cartridge connector of the pressurized cartridge adapter to the valve head of the pressurized cartridge.

In at least one embodiment, aligning the first and second mating interfaces comprises aligning the cartridge connector with the socket insert along a mating direction transverse with regards to a longitudinal axis of the insert body.

### BRIEF DESCRIPTION OF THE DRAWINGS

FIG. 1 is an exploded perspective view of a pressurized cartridge adapter, in accordance with a first embodiment.

FIG. 2 is an exploded side elevation view of the pressurized cartridge adapter of FIG. 1.

FIG. 3 is a cross-sectional view, taken along cross-section line A-A, of the pressurized cartridge adapter of FIG. 1.

FIG. 4 is front perspective view of a socket insert of the pressurized cartridge adapter of FIG. 1.

FIG. 5 is rear perspective view of the socket insert of FIG. 4.

FIG. 6 is a cross-sectional view, taken along cross-section line B-B, of the socket insert of FIG. 4.

FIG. 7 is perspective view of a pin of the pressurized cartridge adapter of FIG. 1.

FIG. 8 is a side elevation view of the pin of FIG. 7.

FIG. 9 is front perspective view of a stopper of the pressurized cartridge adapter of FIG. 1.

FIG. 10 is a rear perspective view of the stopper of FIG. 9.

FIG. 11 is a cross-sectional view, taken along cross-section line C-C, of the stopper of FIG. 9.

FIG. 12 is front perspective view of a cartridge connector of the pressurized cartridge adapter of FIG. 1.

FIG. 13 is a rear perspective view of the cartridge connector of FIG. 12.

FIG. 14 is a side elevation view of the cartridge connector of FIG. 13.

FIG. 15 is a perspective view of a coupler of the pressurized cartridge adapter of FIG. 1.

FIG. 16 is a top plan view of the coupler of FIG. 15.

FIG. 17 is a cross-sectional view, taken along cross-section line D-D, of the coupler of FIG. 15.

FIG. 18 is a bottom perspective view of the socket insert, in accordance with another embodiment.

FIG. 19 is a front elevation view of the socket insert of FIG. 18.

It will be noted that throughout the appended drawings, like features are identified by like reference numerals.

### DETAILED DESCRIPTION

In the present description, the same numerical references refer to similar elements. Furthermore, for the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional, and are given for exemplification purposes only.

Furthermore, in the context of the present description, it will be considered that all elongated objects will have an implicit “longitudinal axis” or “centerline”, such as the longitudinal axis of a shaft for example, or the centerline of a biasing device such as a coiled spring, for example, and that expressions such as “connected” and “connectable”, “secured” and “securable”, “engaged” and “engageable”, “installed” and “installable” or “mounted” and “mountable”, may be interchangeable, in that the present pressurized cartridge adapter also relates to kits with corresponding components for assembling a resulting fully-assembled and fully-operational pressurized cartridge adapter.

It is to be understood that the phraseology and terminology employed herein is not to be construed as limiting and are for descriptive purpose only. The principles and uses of the teachings of the present invention may be better understood with reference to the accompanying description, figures and examples. It is to be understood that the details set forth herein do not construe a limitation to an application of the invention. Furthermore, it is to be understood that the invention can be carried out or practiced in various ways and that the invention can be implemented in embodiments other than the ones outlined in the description above.

Moreover, components of the pressurized cartridge adapter and/or steps of the method(s) described herein could be modified, simplified, altered, omitted and/or interchanged, without departing from the scope of the present disclosure, depending on the particular applications which the present pressurized cartridge adapter is intended for, and the desired end results, as briefly exemplified herein and as also apparent to a person skilled in the art.

Moreover, although the present invention was primarily designed for connecting a pressurized cartridge to a carbonation device, it may be used with other objects and/or in other types of applications, as apparent to a person skilled in the art. For this reason, expressions such as “cartridge”, “carbonation device”, “carbonation machine”, etc., used herein should not be taken so as to limit the scope of the present invention and include all other kinds of objects and/or applications with which the present invention could be used and may be useful. For example, the pressurized cartridge adapter could also be used for connecting a cartridge to any suitable device or machine, as can be easily understood by a person skilled in the art.

Moreover, although the embodiments of the pressurized cartridge adapter and corresponding parts thereof consist of certain geometrical configurations as explained and illustrated herein, not all of these components and geometries are essential and thus should not be taken in their restrictive sense. It is to be understood, as also apparent to a person skilled in the art, that other suitable components and cooperation thereinbetween, as well as other suitable geometrical configurations, may be used for the pressurized cartridge adapter, as will be briefly explained herein and as can be easily inferred herefrom by a person skilled in the art. Moreover, it will be appreciated that positional descriptions such as “above”, “below”, “left”, “right” and the like should, unless otherwise indicated, be taken in the context of the figures and should not be considered limiting.

In the present description, the term “about” means within an acceptable error range for the particular value as determined by one of ordinary skill in the art, which will depend in part on how the value is measured or determined, i.e. the limitations of the measurement system. It is commonly accepted that a 10% precision measure is acceptable and encompasses the term “about”.

The present disclosure describes an adapter configured to be mounted or installed onto a pressurized cartridge and a carbonation device to allow an otherwise incompatible connection therebetween.

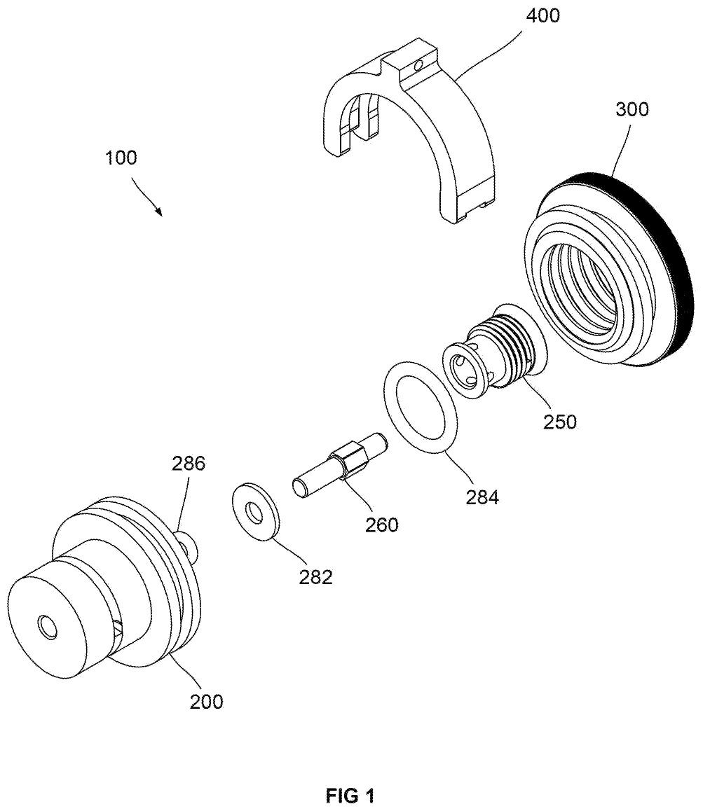

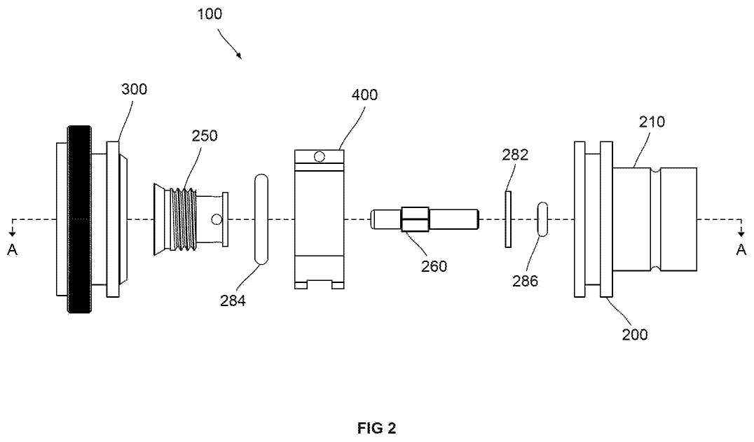

Referring now to the non-limitative embodiment of FIGS. 1 to 3, there is shown a pressurized cartridge adapter 100 in accordance with a non-limitative embodiment comprising a socket insert 200 and a cartridge connector 300. Broadly, the socket insert 200 and the cartridge connector 300 can be assembled to form the pressurized cartridge adapter 100 suitable for connecting a pressurized cartridge (not shown) to an otherwise incompatible carbonation device (not shown). In particular, the pressurized cartridge adapter 100 may serve to translate a force generated by a release mechanism (not shown) of the carbonation device onto a valve (not shown) of the pressurized cartridge. The pressurized cartridge adapter 100 may further channel a pressurized fluid released by the valve of the pressurized cartridge into a valve head socket (not shown) of the carbonation device.

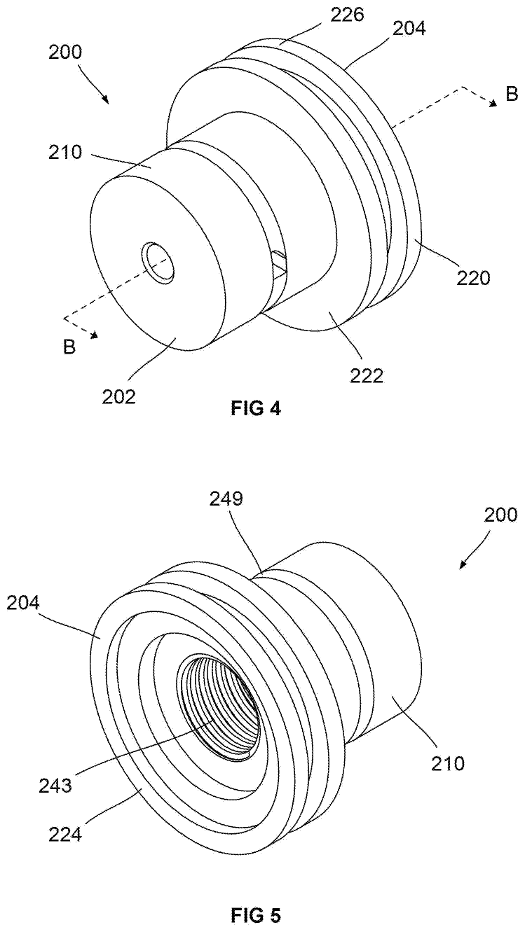

Referring to FIGS. 1 to 6, an embodiment of the socket insert 200 is shown. The socket insert 200 can be configured for insertion into the valve head socket of the carbonation device and includes an elongated body 210 extending from a first end 202 to a second end 204 of the socket insert 200. The elongated body 210 is shaped and dimensioned to enable the insertion of the elongated body 210 within the valve head socket of the carbonation device along a longitudinal axis A₁ of the socket insert 200. Accordingly, the elongated body 210 of the socket insert 200 can include a diameter and a circular transverse cross-sectional shape corresponding to a corresponding diameter and transverse cross-sectional shape of the valve head socket. It will be appreciated that the elongated body 210 may have any other dimensions and shape suitable for insertion within the valve head socket. In certain embodiments, the elongated body 210 may be dimensioned to provide an interference fit with the valve head socket of the carbonation device to prevent an undesirable separation of the elongated body 210 and the valve head socket after installation. In certain embodiments, the elongated body 210 can further include a substantially smooth outer surface 206 configured to provide an unobstructed sliding insertion of the elongated body within the valve head socket.

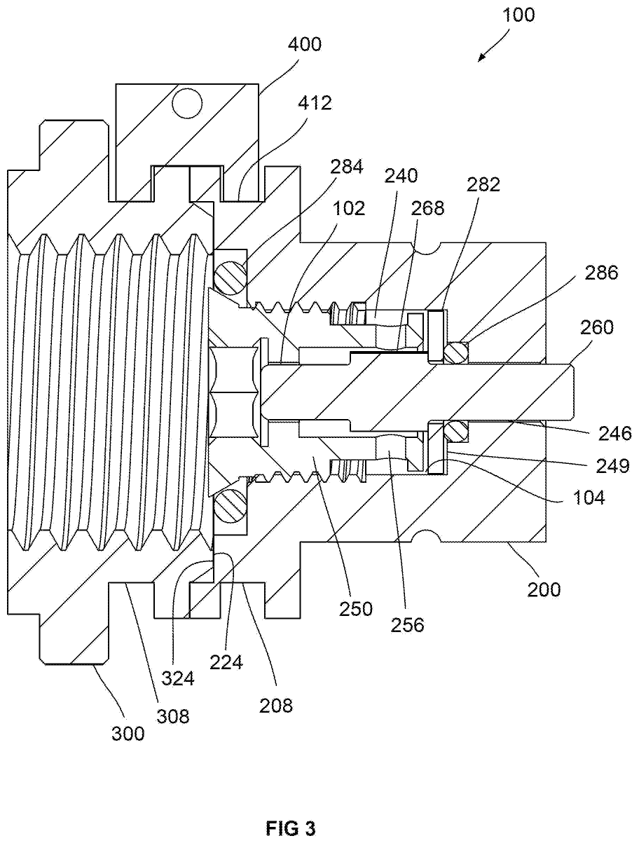

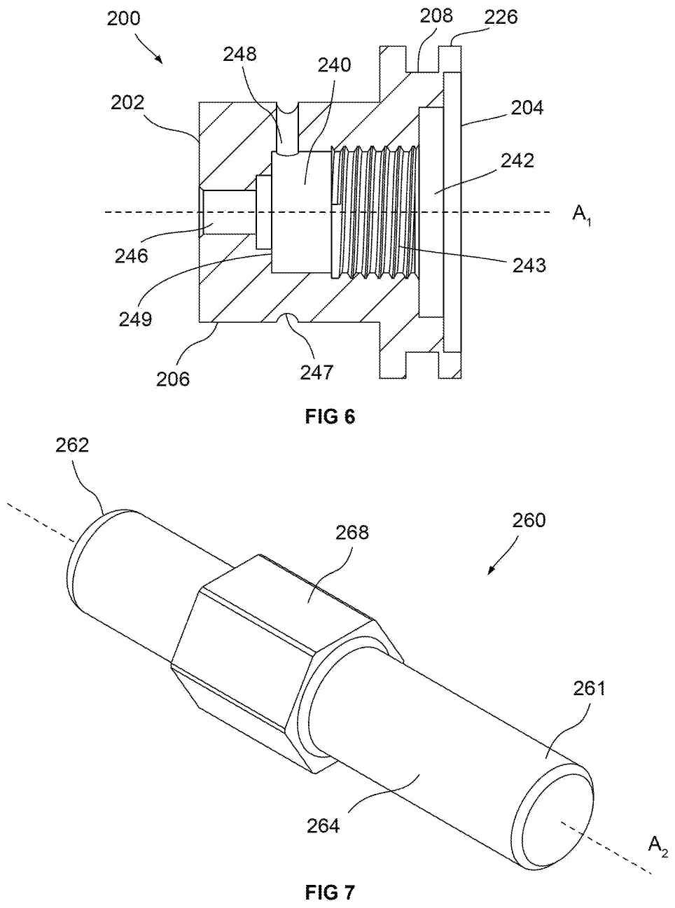

Referring now to FIGS. 3 and 6, the socket insert 200 further includes a bore 240 extending from the first end 202 to the second end 204 of the socket insert 200. The bore 240 can be shaped and dimensioned to slidingly receive a pin 260 therein. As described in greater detail below, the pin 260 is configured to translate within said bore 240 along the longitudinal axis A₁ of the socket insert 200 between a neutral position when the pressurized cartridge adapter 100 is mounted to the pressurized cartridge, and an engaged position when the pressurized cartridge adapter 100 is actuated by the gas release mechanism of the carbonation device to depress the valve of the pressurized cartridge.

Referring specifically to FIG. 6, in the illustrated embodiment, the bore 240 defines a connection portion 242 of the socket insert 200 near the second end 204 thereof. The connection portion 242 can be configured to receive a stopper 250 for limiting a translation of the pin 260 within the bore 240. In certain embodiments, the connection portion 242 of the socket insert 200 may include an internal threaded surface 243 configured to operatively engage a threaded portion 254 of the stopper 250.

In certain embodiments, the bore 240 further includes a pin aperture 246 opposite the connection portion 242 shaped and dimensioned to receive an end of the pin 260, as described in greater detail below. In the illustrated embodiment, each of the connection portion 242 and the pin aperture 246 has a substantially circular cross-section configured to receive a substantially cylindrical stopper 250 and pin 260, respectively. It will be understood that, in other embodiments, either or both of the connection portion 242 and the pin aperture 246 may have any other suitable cross-sectional shape.

As stated above, the pressurized cartridge adapter 100 is configured to channel a pressurized fluid released by the pressurized cartridge into the valve head socket of the carbonation device. In some embodiments, the socket insert 200 can therefore be configured, when the pressurized cartridge adapter 100 is assembled and actuated by the gas release mechanism of the carbonation device, to receive the pressurized fluid released by the pressurized cartridge through the connection portion 242 thereof and to channel said pressurized fluid to an inlet of the valve head socket (not shown). In some embodiments, the pressurized fluid can be channeled from the bore 240 of the socket insert 200 to the inlet of the valve head socket through a pressure conduit 248 extending between the bore 240 and an outer surface 206 of the socket insert 200. In some embodiments, the outer surface 206 of the socket insert 200 can further define an external groove 247 in fluid communication with the pressure conduit 248 and configured to extend about a circumference of the elongated body 210. The external groove 247 can be positioned to channel the pressurized fluid to the inlet of the valve head socket when the socket insert 200 is inserted within the valve head socket with the pressure conduit 248 being misaligned with the inlet of the valve head socket.

In certain embodiments, the socket insert 200 may include an insert flange 220 extending radially from the second end 204 thereof. In the illustrated embodiment, the insert flange 220 comprises a contact interface 222, a first mating interface 224 opposite the contact interface 222, and a peripheral surface 226 extending between the contact interface 222 and the first mating interface 224. The contact interface 222 may be configured to abut an edge surface of the valve head socket when the socket insert 200 is inserted therein so as to limit an insertion depth of the elongated body 210 within the valve head socket. In particular, the insert flange 220 can be configured to limit the insertion of the socket insert 200 within the valve head socket to a depth corresponding to an alignment of one of the pressure conduit 248 and external groove 247 with the inlet of the valve head socket.

In certain embodiments, the insert flange 220 of the socket insert 200 can further define a first attachment recess 208 extending along a circumference of the peripheral surface 226. In the illustrated embodiment, the first attachment recess 208 is shaped as an annular groove extending along an entirety of the circumference of the cylindrical surface 226. Alternatively, in other embodiments, the first attachment recess 208 can be defined along any other suitable surface of the socket insert 200 and can have any other suitable shape. The first attachment recess 208 can be configured to secure the socket insert 200 to the cartridge connector 300, as described in greater detail below.

Referring now to FIGS. 7 and 8, a non-limitative embodiment of the pin 260 is illustrated. Broadly, the pin 260 includes an elongated cylindrical body 264 extending along a longitudinal axis A₂ of the pin 260 coinciding with the longitudinal axis A₁ of the socket insert 200 when the pin 260 is inserted within the bore 240 of the socket insert 200. As stated above, when the pressurized cartridge adapter 100 is in an assembled configuration, a first end 261 of the pin 260 can extend through the pin aperture 246 of the socket insert 200 to be engageable by the gas release mechanism of the carbonation device. Moreover, a second end 262 of the pin 260 can be configured to engage the valve of the pressurized cartridge. In the illustrated embodiment, each of the first and second ends 261, 262 of the pin 260 has a transverse circular cross-section having similar diameters. It is to be understood that, in other embodiments, the first end 261 and the second end 262 may have any other suitable cross-sectional shape with each of the first end 261 and the second end 262 having any suitable diameter.

In certain embodiments, the pin 260 further includes a radial projection 268 extending along a portion of a longitudinal length of the cylindrical body 264. The radial projection 268 can be configured to limit a translation of the pin 260 within the bore 240, as described in greater detail below. In the illustrated embodiment, the radial projection 268 has a hexagonal shape extending over an entirety of a circumference of the cylindrical body 264. Alternatively, the radial projection 268 may extend over a limited arc of the cylindrical body 264 and may have any other suitable shape.

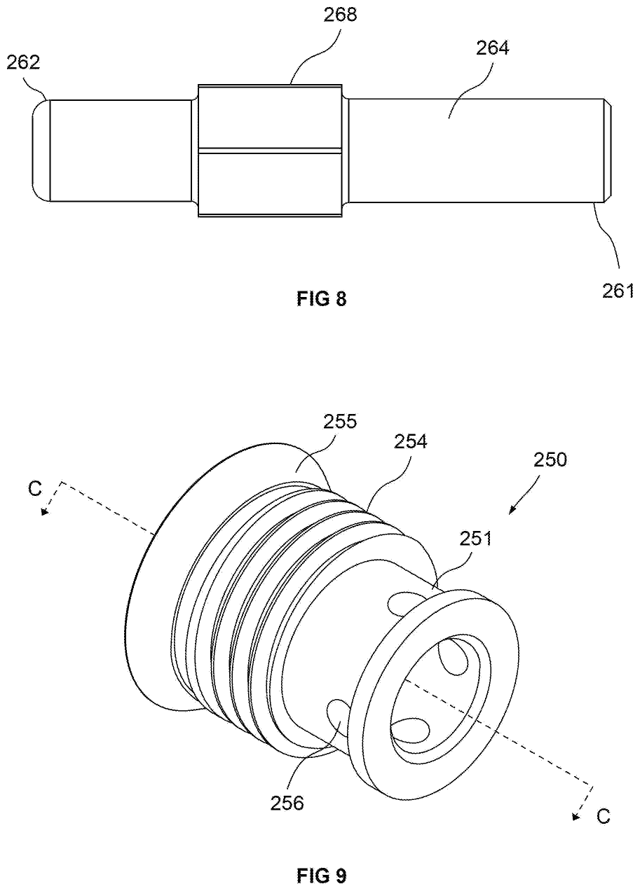

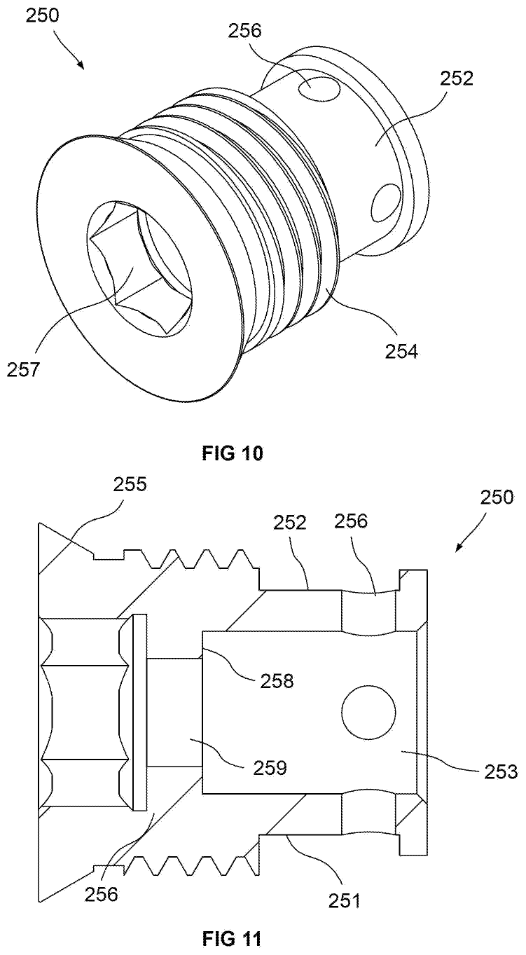

Referring now to FIGS. 9 to 11, an embodiment of the stopper 250 is illustrated. The stopper 250 includes a tubular body 251 defining an interior cavity 253 and an external surface 252 delimited by a skirt 255 at a lower end thereof. The external surface 252 further defines a threaded surface 254 extending along a portion thereof configured to operatively engage the threaded surface 243 of the socket insert 200. In certain embodiments, the tubular body 251 defines one or more orifices 256 extending between the external surface 252 and the interior cavity 253 of the tubular body 251. As stated above, the stopper 250 can be configured to limit a translation of the pin 260 within the bore 240 of the socket insert 200 when the pin is engaged by the gas release mechanism of the carbonation device. Accordingly, the stopper 250 can further comprise an internal rib 258 extending radially from the tubular body 251 into the interior cavity 253 sized to interfere with the radial projection 268 of the pin 260. In the illustrated embodiment, the internal rib 258 defines an opening 259 sized to receive the second end 262 of the pin 260.

In certain embodiments, the stopper 250 can further include a keyed recess 257 configured to allow a manipulation of the stopper 250 within the socket insert 200 during assembly of the pressurized cartridge adapter 100. In particular, the keyed recess 257 can enable a rotation of the stopper 250 within the socket insert 200 to threadingly engage the two together to secure the stopper 250 to the socket insert 200 and to enclose the pin 260 within the bore 240. In the illustrated embodiment, the keyed recess 257 defines a hexagonal aperture configured to receive a hexagonally shaped tool such as an Allen key. Alternatively, the keyed portion 257 may instead include one or more recesses, raised portions, concavely or convexly curved portions, or have any other feature configured to enable a manipulation of the stopper 250 within the socket insert 200. In the illustrated embodiment, the keyed recess 257 is further shaped and dimensioned to receive the valve head of the pressurized cartridge to position the valve of the pressurized cartridge in proximity to the opening 259 and the second end 262 of the pin 260. While an embodiment of the stopper 250 has been described herein, it is to be understood that the stopper 250 can have any other suitable shape for being secured to the socket insert 200 and enclosing the pin 260 within the bore 240 of the socket insert 200. In certain embodiments, the socket insert 200 and the stopper 250 can further be unitary.

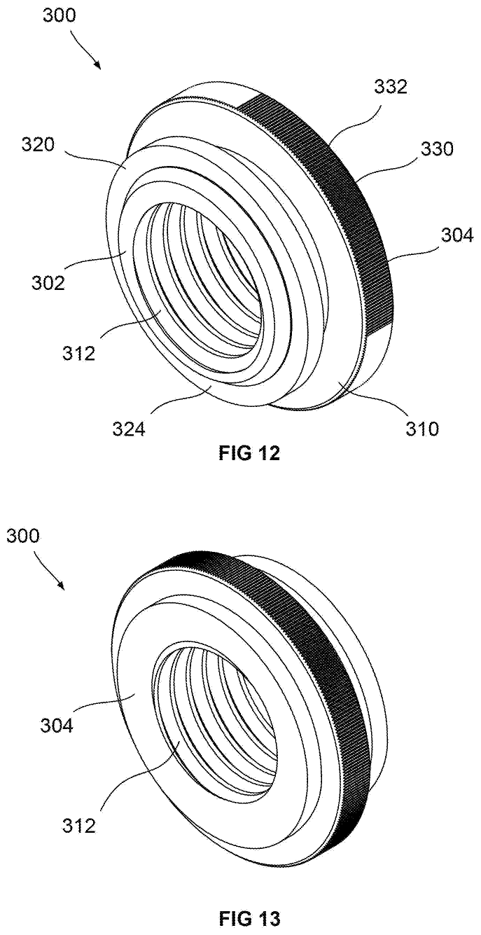

Referring now to FIGS. 12 to 14, a non-limitative embodiment of the cartridge connector 300 is illustrated. The cartridge connector 300 includes an annular body 310 extending from a first end 302 to a second end 304 thereof. In some embodiments, the annular body 310 can define an internally threaded surface 312 configured to be mated to an external threaded portion of the valve head of the pressurized cartridge. In particular, in certain embodiments, the internally threaded surface 312 can extend over an entire longitudinal length of the annular body 310 so as to enable a complete threading of the annular body 310 onto the valve head of the pressurized canister (i.e., a mounting of the annular body 310 onto the valve head of the pressurized cartridge whereby the first end 302 of the annular body 310 does not exceed an edge of the pressurized cartridge). It is to be understood that, in other embodiments, the cartridge connector 300 can be secured to the valve head of the pressurized cartridge using any other suitable means including, for instance, a fastener or an adhesive. In some embodiments, the cartridge connector 300 comprises a connector flange 320 extending radially from the annular body 310 proximate the first end 302 of the cartridge connector 300, and a grip flange 330 extending radially from the annular body 310 proximate the second end 304 of the cartridge connector 300. In certain embodiments, the grip flange 330 can include a knurled surface 332 configured to improve a user's grip of the cartridge connector 300 when being threaded or unthreaded onto the valve head of the pressurized cartridge.

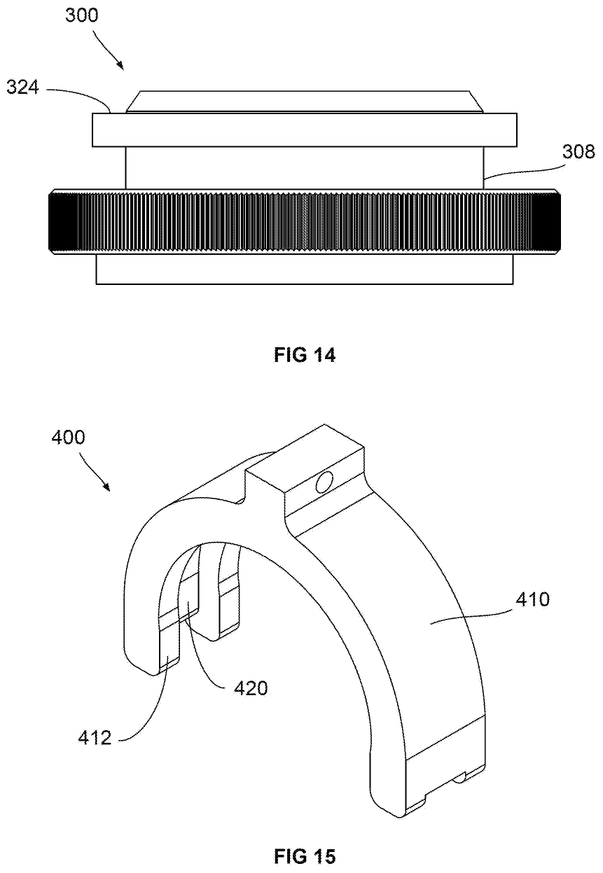

In some embodiments, the connector and grip flanges 320, 330 can be axially spaced to define a second attachment recess 308 configured to enable an assembly of the cartridge connector 300 with the socket insert 200 (shown in FIG. 14). In the illustrated embodiment, the second attachment recess 308 comprises an annular groove extending about an entire circumference of the cartridge connector 300. Alternatively, the second attachment recess 308 can be disposed on any other suitable surface of the cartridge connector 300 and can comprise any other suitable shape. In some embodiments, the connector flange 320 can further define a second mating interface 324 configured to interface with the first mating interface 224 of the socket insert 200 when the pressurized cartridge adapter 100 is assembled. Referring again to FIG. 3, the first and second mating interfaces 224, 324 comprise complementary profiles for interlocking of the socket insert 200 and cartridge connector 300 when the pressurized cartridge adapter 100 is assembled. It will be appreciated that each of the first and second mating interfaces 224, 324 may not be fully planar and could instead include one or more recesses, raised portions, concavely or convexly curved portions, or have any other configuration that would be suitable to interface with the corresponding other first and second mating interfaces 224, 324.

As stated above, the pressurized cartridge adapter 100 can be configured to connect a pressurized cartridge to an otherwise incompatible carbonation device. In some embodiments, the pressurized cartridge adapter 100 can be sized to fit, along with the pressurized cartridge, within a cartridge compartment of the carbonation device without requiring a modification of said carbonation device. Accordingly, in some embodiments, the socket insert 200 having been inserted into the valve head socket of the carbonation device, and the cartridge connector 300 having been mounted onto the valve head of the pressurized cartridge can be configured to be assembled without necessitating a displacement of the pressurized cartridge along a longitudinal axis thereof. In particular, the socket insert 200 and the cartridge connector 300 can be assembled by a motion performed in a coupling direction being transverse to the longitudinal axis of the pressurized cartridge adapter 100 and the pressurized cartridge (i.e., in a direction transverse to the longitudinal axis A₁ of the socket insert 200) to enable a mounting of the pressurized canister within the cartridge compartment of the carbonation device without necessitating excess additional space within the cartridge compartment. In the illustrated embodiment, the first and second mating interfaces 224, 324 can be substantially planar in a direction transverse to the longitudinal axis A₁ of the socket insert 200 when the pressurized cartridge adapter 100 is assembled to enable an assembly and disassembly of the pressurized cartridge adapter 100 along the coupling direction.

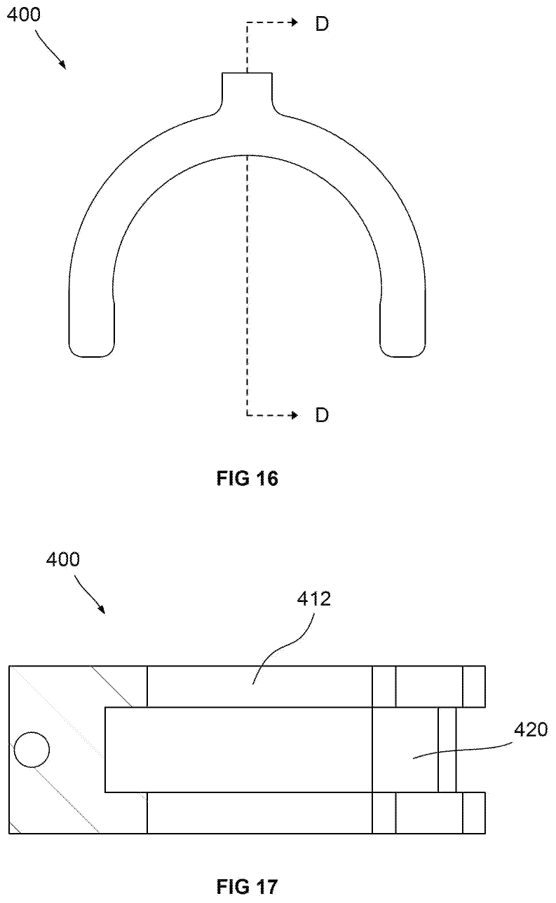

Referring now to FIGS. 15 to 17, a coupler 400 configured to secure the pressurized cartridge adapter 100 is illustrated. In particular, the coupler 400 can be configured to secure the socket insert 200 and the cartridge connector 300 to one another. Alternatively, in other embodiments, the coupler 400 can be configured to secure one of the socket insert 200 and the cartridge connector 300 to the carbonation device or to any other suitable structure. In the illustrated embodiment, the coupler 400 includes an arcuate body 410 defining an internal surface 412. In certain embodiments, the coupler 400 may further comprise one or more fastening grooves extending over at least a portion of the internal surface 412 of the arcuate body 410 and sized to receive both the insert flange 220 and the connector flange 320 when the pressurized cartridge adaptor 100 is assembled to prevent a separation of the socket insert 200 and the cartridge connector 300 in the direction of the longitudinal axis A₁ of the socket insert 200. In the illustrated embodiment, the coupler 400 comprises a fastening groove 420 extending over an entirety of the internal surface 412 of the arcuate body 410. In certain embodiments, the fastening groove 420 can further be sized to receive the insert flange 220 and the connector flange 320 with an interference fit.

In the illustrated embodiment, the arcuate body 410 extends over an arc being about 180°. Alternatively, in other embodiments, the arcuate body 410 can extend over an arc being greater than 180° to clutch a circumference of the socket insert 200 and the cartridge connector 300 thereby generating a desirable resistive force to prevent an undesirable release of the coupler 400 from the socket insert 200 and the cartridge connector 300.

As stated above, the coupler 400 may be configured to secure the socket insert 200 and the cartridge connector 300 to restrict an axial displacement relative to one another when the pressurized cartridge adapter 100 is channeling a pressurized fluid. In other embodiments, the first and second mating interfaces 224, 324 may include a configuration suitable for interlocking said first and second mating interfaces 224, 324 to prevent a relative axial displacement. In other embodiments still, the socket insert 200 and the cartridge connector 300 can be sized to occupy, in association with the pressurized cartridge, a total length of the compartment of the carbonation device to limit an axial displacement between the socket insert 200 and the cartridge connector 300.

Referring again to FIG. 3, a cross-sectional view of the pressurized cartridge adapter 100 is illustrated in the assembled configuration. As shown, the pin 260 can extend within the bore 240 of the socket insert 200 with the first end 261 of the pin 260 extending through the pin aperture 246 of the socket insert 200, and the second end 262 extending through the opening 259 of the stopper 250. In the illustrated embodiment, the pin 260 is shown in the neutral position (i.e., when the pressurized cartridge adapter 100 is mounted to the pressurized cartridge and the pin is not actuated by the gas release mechanism of the carbonation device) with the radial projection 268 limiting a translation of the pin 260 through the pin aperture 246 of the socket insert 200. In this position, the second end 262 of the pin 260 extends through the opening 259 of the stopper 250 to contact the valve of the pressurized cartridge. When the pin 260 is actuated by the gas release mechanism of the carbonation device, the pin 260 can translate within the bore 240 along the longitudinal axis A₁ of the socket insert 200 to further extend through the opening 259 of the stopper 250 thereby depressing the valve of the pressurized cartridge to release the pressurized fluid contained therein. When actuated, the translation of the pin 260 can further be limited by a contact between the radial projection 268 and the internal rib 258 of the stopper 250 to define the engaged position of the pin 260. A length of the pin 260 can be selected such that the pin 260 extends through the pin aperture 246 of the socket insert 200 to remain engageable by the gas release mechanism of the carbonation device, and through the opening 259 of the stopper 250 to contact the valve of the pressurized cartridge when in the neutral position.

In certain embodiments, the socket insert 200 can define an internal stop 249 to limit the translation of the pin 260 when in the neutral position. In certain embodiments, the socket insert 200 can further include a resilient damper 282 configured to dampen an impact between the pin 260 and the internal stop 249 when being translated within the bore 240 of the socket insert. In the illustrated embodiment, the damper 282 comprises an annular disk although it will be appreciated that the damper 282 may have any other suitable shape and size.

In certain embodiments, the pressurized cartridge adapter 100 can further include one or more gaskets configured to hydraulically seal one or more joints of the assembled pressurized cartridge adapter 100. In the embodiment shown in FIGS. 1 to 3, the pressurized cartridge adapter 100 includes a first gasket 284 and a second gasket 286 configured to hydraulically seal a junction between the socket insert 200 and the stopper 250, as well as a junction between the socket insert 200 and the pin 260, respectively. More specifically, in the illustrated embodiment, the first gasket 284 comprises a resilient ring gasket disposed between the bore 240 of the socket insert 200 and the skirt 255 of the stopper 250. Similarly, the second gasket 286 comprises a resilient ring gasket disposed between the pin 260 and the internal stop 249 of the socket insert 200. It will be appreciated that the first and second gaskets 284, 286 may have any other suitable shape and may be disposed in any other suitable position.

As previously stated, the pressurized cartridge adapter 100 is adapted to channel the pressurized fluid released by the valve of the pressurized cartridge into the valve head socket of the carbonation device. The pressurized cartridge adapter 100 can further serve to translate a force generated by the release mechanism of the carbonation device onto the valve of the pressurized cartridge. In particular, the release mechanism of the carbonation device can impel the pin 260 to translate within the bore 240 of the socket insert 200 and into the opening 259 of the stopper 250. As the second end 262 of the pin 260 extends beyond the opening 259, it may engage the valve of the pressurized cartridge to occasion a release of the pressurized fluid. When the pressurized cartridge adapter 100 is assembled, the pressurized fluid is directed into a first channel 102 (shown in FIG. 3) formed between the pin 260 and the aperture 259 of the stopper 250 and into the interior cavity 253 of the stopper 250. In certain embodiments, the pressurized fluid may further be directed around the radial projection 268 of the pin and across the orifices 256 of the stopper 250 and/or a second channel 104 formed between the stopper 250 and the resilient damper 282. Finally, the pressurized fluid may be channeled through the pressure conduit 248 of the socket insert 200 to reach the inlet of the valve head of the carbonation device.

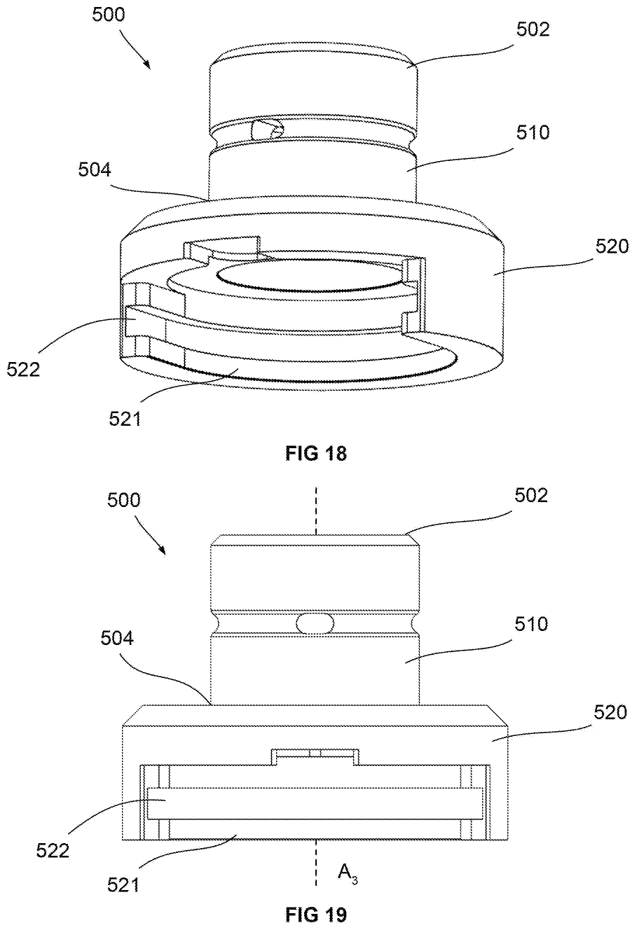

Referring now to FIGS. 18 and 19, there is shown a socket insert 500 in accordance with another non-limitative embodiment. In this illustrated embodiment, the socket insert 500 includes a socket body 510 extending from a first end 502 to a second end thereof. The socket insert 500 further includes a peripheral wall 520 extending from the second end 504 of socket body 510 along a portion of a circumference of the socket body 510 to define an attachment recess 522. More specially, the attachment recess 522 is defined as an annular groove extending along an inner face 521 of the peripheral wall 520. The attachment recess 522 can be sized to receive both the connector flange 320 and the coupler 400 when the pressurized cartridge adaptor 100 is assembled to prevent a separation of the socket insert 500 and the cartridge connector 300 in the direction of a longitudinal axis A₃ of the socket insert 500. Moreover, the peripheral wall 520 can be sized to enable an insertion of the connector flange 320 and the coupler 400 within the attachment recess 522 in a coupling direction being transverse to the longitudinal axis of the pressurized cartridge adapter 100 and the pressurized cartridge (i.e., in a direction transverse to the longitudinal axis A₃ of the socket insert 500).

In the above description, an embodiment of the pressurized cartridge adapter 100 has been described and illustrated for use with a pressurized cartridge. It will be appreciated however that the pressurized cartridge adapter 100 may be configured to connect any other pressurized container or conduit to any other suitable machine. For example, in other embodiments, the pressurized cartridge adapter 100 may be configured to be mounted onto a pressurized conduit or piping.

In the above description, an embodiment is an example or implementation of the inventions. The various appearances of “one embodiment,” “an embodiment” or “some embodiments” do not necessarily all refer to the same embodiments. Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

Although various features of the invention may be described in the context of a single embodiment, the features may also be provided separately or in any suitable combination. Conversely, although the invention may be described herein in the context of separate embodiments for clarity, the invention may also be implemented in a single embodiment.

It is to be understood that the terms “including”, “comprising” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element. It is to be understood that where the claims or specification refer to “a” or “an” element, such reference is not be construed that there is only one of that element.

Several alternative embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind. The scope of the invention is therefore intended to be limited solely by the scope of the appended claims.

1. A pressurized cartridge adapter for connecting a pressurized cartridge to a carbonation device, the pressurized cartridge adapter comprising:
a socket insert comprising an insert body defining a bore and a first mating interface, the insert body being at least partially insertable into a valve head socket of the carbonation device;
a pin displaceable within the bore of the socket insert; and
a cartridge connector configured to be secured to a valve head of the pressurized cartridge, the cartridge connector comprising an annular body defining an internal conduit and a second mating interface;
wherein the pressurized cartridge adapter is configurable into an assembled configuration in which socket insert is at least partially inserted into the valve head socket, the first and second mating interfaces mate with each other and the bore of the socket insert is in fluid connection with the internal conduit of the cartridge connector; and
wherein, when the pressurized cartridge adapter is in the assembled configuration, the pin is displaceable within the bore between a neutral position and a gas-releasing position in which, upon actuation of a gas release mechanism of the carbonation device, a fluid released by the pressurized cartridge is channeled into the valve head socket of the carbonation device.

2. The pressurized cartridge adapter of claim 1, wherein, when the socket insert is inserted within the valve head socket of the carbonation device and the cartridge connector is secured to the valve head of the pressurized cartridge, the first and second mating interfaces define a mating direction transverse with regards to a longitudinal axis of the insert body.

3. The pressurized cartridge adapter of claim 2, wherein the first and second mating interfaces are planar surfaces.

4. The pressurized cartridge adapter of claim 1, further comprising a coupler configured to secure the socket insert and the cartridge connector together when the pressurized cartridge adapter is in the assembled configuration.

5. The pressurized cartridge adapter of claim 4, wherein the coupler comprises a fastening groove configured to receive an insert flange of the socket insert and a connector flange of the cartridge connector when the pressurized cartridge adapter is in the assembled configuration.

6. The pressurized cartridge adapter of claim 4, wherein the socket insert comprises an internal surface at least partially delimiting the bore, an attachment recess extending along a portion of the internal surface and being configured to receive at least a portion of the coupler and a connector flange of the cartridge connector.

7. The pressurized cartridge adapter of claim 1, wherein the socket insert defines a pressure conduit in fluid communication with the bore and opening into an outer surface of the socket insert, the pressure conduit being positioned to channel the pressurized fluid to an inlet of the valve head socket of the carbonation device upon actuation of the gas release mechanism.

8. The pressurized cartridge adapter of claim 7, wherein an external groove is formed in the outer surface of the socket insert and extends about a circumference thereof, the external groove being configured to channel the pressurized fluid between the pressure conduit of the socket insert and the inlet of the valve head socket of the carbonation device.

9. The pressurized cartridge adapter of claim 7, wherein the socket insert comprises an insert flange extending radially outwardly from the insert body, the insert flange comprising a valve-abutting interface configured to abut the valve head socket of the carbonation device when in the assembled configuration.

10. The pressurized cartridge adapter of claim 9, wherein, when the pressurized cartridge adapter is in the assembled configuration, the pressure conduit of the socket insert is in register with an inlet of the valve head socket.

11. The pressurized cartridge adapter of claim 1, wherein the cartridge connector includes a threaded surface at least partially delimiting the internal conduit and configured to engage the valve head of the pressurized cartridge, and wherein the insert body of the socket insert is configured to be slidingly received within the valve head socket of the carbonation device.

12. The pressurized cartridge adapter of claim 1, wherein the pin comprises a first end engageable with a pin aperture of the socket insert, and a second end opposite the first end operatively connected to a valve of the valve head when the pressurized cartridge adapter is in the assembled configuration.

13. The pressurized cartridge adapter of claim 1, further comprising a stopper insertable into the bore of the socket insert and defining a pin-receiving cavity.

14. The pressurized cartridge adapter of claim 13, further comprising a gasket arranged in the bore of the socket and surrounding the stopper to hydraulically seal the pressurized cartridge adapter when in the assembled configuration.

15. The pressurized cartridge adapter of claim 13, wherein the stopper comprises an internal rib extending within the pin-receiving cavity and configured to limit a translation of the pin within the bore of the socket insert.

16. The pressurized cartridge adapter of claim 1, further comprising a resilient damper insertable into the bore of the socket insert and configured to dampen a displacement of the pin within the bore of the socket insert.

17. A method of connecting a pressurized cartridge to a carbonation device, the method comprising:
at least partially inserting a socket insert of a pressurized cartridge adapter into a valve head socket of the carbonation device along a longitudinal direction of the socket insert;
securing a cartridge connector of the pressurized cartridge adapter to a valve head of the pressurized cartridge; and
coupling a first mating interface of the socket insert with a second mating interface of the cartridge connector to position a bore of the socket insert in fluid communication with an internal conduit of the cartridge connector.

18. The method of claim 17, wherein at least partially inserting the socket insert of the pressurized cartridge adapter into the valve head socket of the carbonation device comprises abutting a valve-abutting interface of the socket insert with the valve head socket to position a pressure conduit of the socket insert in register with an inlet of the valve head socket.

19. The method of claim 17, wherein securing the cartridge connector of the pressurized cartridge adapter to the valve head of the pressurized cartridge comprises threading the cartridge connector of the pressurized cartridge adapter to the valve head of the pressurized cartridge.

20. The method of claim 17, wherein aligning the first and second mating interfaces comprises aligning the cartridge connector with the socket insert along a mating direction transverse with regards to a longitudinal axis of the insert body.
